(19) United States
(12) Patent Application Publication
(10) Pub. No.: US 2016/0161426 A1
(43) Pub. Date: Jun. 9, 2016

(54) Pillar Based Amorphous and Polycrystalline Photoconductors for X-ray Image Sensors

(71) Applicant: ZENA TECHNOLOGIES, INC., Cambridge, MA (US)

(72) Inventor: Munib Wober, Topsfield, MA (US)

(21) Appl. No.: 14/563,781

(22) Filed: Dec. 8, 2014

(51) Int. Cl. G01N 23/04; G21K 1/06; G01N 23/20

(52) U.S. Cl. CPC G01N 23/046; G01N 23/20091; G21K 1/06

(57) ABSTRACT

Sensors and devices for detecting X-rays are described herein. A device for detecting X-rays may include a first electrode, a second electrode, a microstructure, and an insulating photon absorbing material. The microstructure is configured to provide an electrical path between the first electrode and the second electrode such that at least a portion of charge carriers generated in the photon absorbing material by incident X-ray are collected in a direction different from the direction of the incident X-ray.

### RELATED APPLICATIONS

The disclosures of U.S. patent application Ser. No. 12/204,686, filed Sep. 4, 2008 (now U.S. Pat. No. 7,646,943), Ser. No. 12/648,942, filed Dec. 29, 2009 (now U.S. Pat. No. 8,229,255), Ser. No. 13/556,041, filed Jul. 23, 2012, Ser. No. 12/270,233, filed Nov. 13, 2008 (now U.S. Pat. No. 8,274,039), Ser. No. 13/925,429, filed Jun. 24, 2013, Ser. No. 13/570,027, filed Aug. 8, 2012 (now U.S. Pat. No. 8,471,190), Ser. No. 12/472,264, filed May 26, 2009 (now U.S. Pat. No. 8,269,985, Ser. No. 13/621,607, filed Sep. 17, 2012 (now U.S. Pat. No. 8,514,411), Ser. No. 13/971,523, filed Aug. 20, 2013 (now allowed), Ser. No. 12/472,271, filed May 26, 2009 (now abandoned), Ser. No. 12/478,598, filed Jun. 4, 2009 (now U.S. Pat. No. 8,546,742), Ser. No. 14/021,672, filed Sep. 9, 2013, Ser. No. 12/573,582, filed Oct. 5, 2009 (now allowed), Ser. No. 14/274,448, filed May 9, 2014, Ser. No. 12/575,221, filed Oct. 7, 2009 (now U.S. Pat. No. 8,384,007), Ser. No. 12/633,323, filed Dec. 8, 2009 (now U.S. Pat. No. 8,735,797), Ser. No. 14/068,864, filed Oct. 31, 2013, Ser. No. 14/281,108, filed May 19, 2014, Ser. No. 13/494,661, filed Jun. 12, 2012 (now U.S. Pat. No. 8,754,359), Ser. No. 12/633,318, filed Dec. 8, 2009 (now U.S. Pat. No. 8,519,379), Ser. No. 13/975,553, filed Aug. 26, 2013 (now U.S. Pat. No. 8,710,488), Ser. No. 12/633,313, filed Dec. 8, 2009, Ser. No. 12/633,305, filed Dec. 8, 2009 (now U.S. Pat. No. 8,299,472), Ser. No. 13/543,556, filed Jul. 6, 2012 (now allowed), Ser. No. 12/621,497, filed Nov. 19, 2009 (now abandoned), Ser. No. 12/633,297, filed Dec. 8, 2009, Ser. No. 12/982,269, filed Dec. 30, 2010, Ser. No. 12/966,573, filed Dec. 13, 2010, Ser. No. 12/967,880, filed Dec. 14, 2010 (now U.S. Pat. No. 8,748,799), Ser. No. 12/966,514, filed Dec. 13, 2010, Ser. No. 12/974,499, filed Dec. 21, 2010 (now U.S. Pat. No. 8,507,840), Ser. No. 12/966,535, filed Dec. 13, 2010, Ser. No. 12/910,664, filed Oct. 22, 2010, Ser. No. 12/945,492, filed Nov. 12, 2010, Ser. No. 13/047,392, filed Mar. 14, 2011 (now allowed), Ser. No. 13/048,635, filed Mar. 15, 2011 (now allowed), Ser. No. 13/106,851, filed May 12, 2011, Ser. No. 13/288,131, filed Nov. 3, 2011, Ser. No. 14/032,166, filed Sep. 19, 2013, Ser. No. 13/543,307, filed Jul. 6, 2012, Ser. No. 13/963,847, filed Aug. 9, 2013, Ser. No. 13/693,207, filed Dec. 4, 2012, 61/869,727, filed Aug. 25, 2013, Ser. No. 14/322,503, filed Jul. 2, 2014, and Ser. No. 14/311,954, filed Jun. 23, 2014, are each hereby incorporated by reference in their entirety.

### FIELD OF INVENTION

The present disclosure is related to optical sensors, particularly to sensors for detecting X-rays.

### BACKGROUND

X-ray sensors are used in a wide variety of applications including medical, security and industrial imaging. In particular, in medical applications such as mammography, chest radiology, angiography, fluoroscopy, and computed tomography X-ray imaging offer several advantages over other types of imaging. Digital flat-panel X-ray detectors make it possible to view combine X-ray and magnetic resonance images (MRI) to more accurately guide medical diagnosis and intervention. In many applications, shadow imaging is used when imaging an X-ray image of an object due to a lack of practical means to focus X-rays. Shadow images are typically larger than the object being imaged, and therefore, in many applications, it is desirable to have large flat panel X-ray image sensors. Conventional flat panel X-ray imagers include direct conversion imagers and indirect conversion imagers. In indirect conversion imagers X-rays are first converted to optical wavelengths e.g., via a scintillating phosphor such as CsI:Tl, and the optical wavelengths emitted from the scintillating phosphor represent the signal, which is detected by an array of photodiodes. Direct conversion imagers use an X-ray photoconductor as a detecting element to convert the absorbed X-ray photons directly to collectable charge carriers which represent the signal.

Several X-ray photoconductors have been explored for potential use in commercial applications. Most of these X-ray photoconductors, however, suffer from drawbacks such as high dark currents, or insufficient charge collection efficiency. Moreover, technological problems in manufacturing uniform and homogenous layers of photoconductors over a large area exist.

### SUMMARY

In an embodiment according to the present disclosure, an X-ray photodetector device is described.

In an embodiment according to the present disclosure, a device for detecting X-rays may include a substrate having a plurality of pixels thereon. Each of the pixels may include a first electrode, and a second electrode electrically connected with the first electrode via an insulating photon absorbing material having an attenuation depth of less than about 8 μm for photons having an energy of about 5 keV. A portion of the insulating photon absorbing material forms a vertical microstructure.

In an embodiment according to the present disclosure, a method for detecting X-rays may include obtaining a device including a substrate having a plurality of pixels thereon, exposing the device to X-ray photons, and processing an electrical signal resulting from the X-ray photons impinging on the device. Each of the pixels of the device include a first electrode, a second electrode electrically connected with the first electrode via an insulating photon absorbing material having an attenuation depth of less than about 8 μm for photons having an energy of about 5 keV. A portion of the insulating photon absorbing material comprises a vertical microstructure.

In an embodiment according to the present disclosure, a method for making an X-ray imaging device may include obtaining a first X-ray detector device and a second X-ray detector device, and bonding a top side of the first X-ray detector device with a bottom side of the second X-ray detector device such that a vertical microstructure of the first X-ray detector device and a vertical microstructure of the second X-ray detector device extend away from each other. The first and the second X-ray detector devices each include a substrate having a plurality of pixels thereon. Each of the pixels include a first electrode, and a second electrode electrically connected with the first electrode via an insulating photon absorbing material having an attenuation depth of less than about 8 μm for photons having an energy of about 5 keV. A portion of the comprises insulating photon absorbing material a vertical microstructure; and

In an embodiment according to the present disclosure, a system for real-time tomography is described. The system may include an X-ray source for projecting X-rays through a screening area, a conveyor configured to direct an object to be screened to pass through the scanning area, an X-ray detector configured to detect X-rays transmitted through an object present in the scanning area, and an electronic display configured to display an image of the screened object, the image being constructed based on signals received by the X-ray detector. The X-ray detector may include a substrate having a plurality of pixels thereon. Each of the pixels may include a first electrode, and a second electrode electrically connected with the first electrode via an insulating photon absorbing material having an attenuation depth of less than about 8 μm for photons having an energy of about 5 keV. A portion of the insulating photon absorbing material forms a vertical microstructure.

In an embodiment according to the present disclosure, a system for medical imaging is described. The system may include an X-ray source for projecting X-rays through an examination region, an X-ray detector configured to detect X-rays transmitted through a subject present in the examination region, and an electronic display configured to display an image constructed from signals received by the X-ray detector. The X-ray detector may include a substrate having a plurality of pixels thereon. Each of the pixels may include a first electrode, and a second electrode electrically connected with the first electrode via an insulating photon absorbing material having an attenuation depth of less than about 8 μm for photons having an energy of about 5 keV. A portion of the insulating photon absorbing material forms a vertical microstructure.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

This disclosure is not limited to the particular systems, devices and methods described, as these may vary. The terminology used in the description is for the purpose of describing the particular versions or embodiments only, and is not intended to limit the scope.

### BRIEF DESCRIPTION OF THE DRAWINGS

In the present disclosure, reference is made to the accompanying drawings, which form a part hereof. In the drawings, similar symbols typically identify similar components, unless context dictates otherwise. Various embodiments described in the detailed description, drawings, and claims are illustrative and not meant to be limiting. Other embodiments may be used, and other changes may be made, without departing from the spirit or scope of the subject matter presented herein. It will be understood that the aspects of the present disclosure, as generally described herein, and illustrated in the Figures, can be arranged, substituted, combined, separated, and designed in a wide variety of different configurations, all of which are contemplated herein.

FIG. 1 depicts a schematic cross-section of a single pixel of a flat panel X-ray imager, in accordance with an embodiment of the present disclosure.

FIG. 2 depicts a plot of asymmetry parameter for 3p, 3d, and 4p electrons versus electron energy.

FIG. 3 depicts angular velocity distribution of X-ray ejected electrons relative to polarization axis of impinging photon.

FIG. 4 depicts a modified diffusion model of electron beam penetration in a target.

FIG. 5 depicts voltage dependence of mass-range on atomic number.

FIG. 6 depicts a schematic cross-section of a single pixel of an FPXI, in accordance with an embodiment of the present disclosure.

FIG. 7 depicts a schematic cross-section of a single pixel of an FPXI, in accordance with an embodiment of the present disclosure.

FIGS. 8A and 8B depict a schematic cross-section of an FPXI pixel array having a stacked (also referred to herein as “double-sided”) configuration, in accordance with an embodiment of the present disclosure.

FIG. 9 depicts a flat panel X-ray imager (FPXI) having an array of micro pillars of a photoconductor material, in accordance with an embodiment of the present disclosure.

FIG. 10 depicts a FPXI having an array of pillars with a central electrode, in accordance with an embodiment of the present disclosure.

FIG. 11 depicts a FPXI having an array of pillars of a photoconductor material in a double sided configuration, in accordance with an embodiment of the present disclosure.

FIG. 12 depicts a schematic of a real-time tomography imaging system, in accordance with an embodiment of the present disclosure.

FIG. 13 depicts a schematic of a medical imaging system, in accordance with an embodiment of the present disclosure.

### DETAILED DESCRIPTION

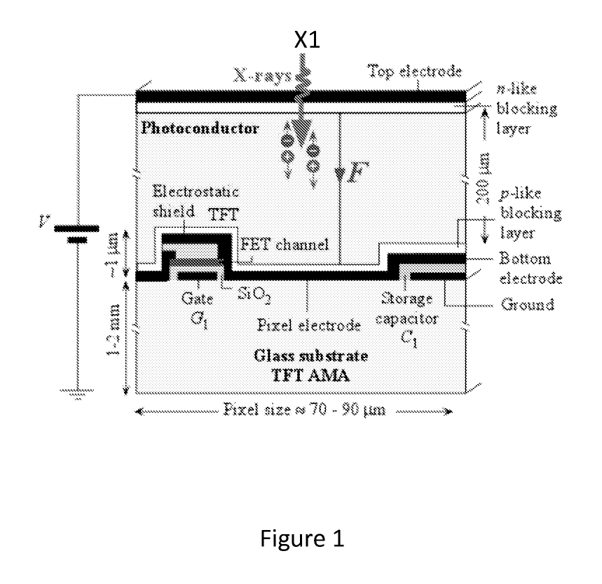

FIG. 1 depicts a schematic cross-section of a single pixel of a flat panel X-ray imager. A flat panel x-ray imager (FPXI) may consist of a large array of pixels as part of an active matrix array (AMA). An AMA is a two dimensional array of pixels. Each of the pixels, as illustrated in FIG. 1, may have a thin film transistor (TFT) that can be externally addressed. Each pixel may be identical. The gate of the TFT may be connected to a particular address line and the source of the TFT may be connected to a particular data line. The AMA has M×N number of gate and data lines in which M and N can be very large, e.g. 2,816×3,584.

The active matrix array may be coated by a suitable X-ray photoconductor material, such as, for example, stabilized amorphous selenium (a-Se). Other examples of X-ray photoconductor material include insulators with heavy elements such as, for example, mercury iodide (HgI₂), cadmium zinc telluride (Cd_{0.95}Zn_{0.05}Te), lead iodide (PbI₂), lead oxide (PbO), thallium bromide (TlBr), and the like or any combinations thereof. An electrode may be provided on a surface of the X-ray photoconductor material to allow the application of a bias voltage as illustrated in FIG. 1. Thus, each pixel of the AMA acts as an individual X-ray detector and has a biased photoconductor.

When incident X-ray is absorbed in a photoconductor medium, as a result of the photoelectric effect, an energetic primary electron is knocked out from an inner core shell, for example the K-shell. The primary electron has a large kinetic energy given by (Eₚₕ−E_{binding}), where Eₚₕ is the X-ray photon energy and E_{binding} is the binding energy of the electron in the shell from which it was knocked out. The energetic primary electron is ejected in a direction not necessarily collinear with impinging X-ray photon and as it travels in the medium, it interacts with and transfers energy to the medium. This may result, depending on the energy of the impinging X-ray photon, in generation of many electron hole pairs, as well as phonons. Phonons essentially represent losses. The electron and hole pairs may be collected under appropriate conditions (e.g., providing a suitable bias across the photoconductor material, as depicted in FIG. 1). When an electric field is applied across the photoconductor, the carriers drift to their respective electrodes under the field and are collected at the respective electrodes. The photoconductor, thus, converts the incident X-ray radiation energy to electric charges, which constitute the signal.

As shown in the embodiment illustrated in FIG. 1, there may be a storage capacitor at each pixel to collect charges that are generated by the photoconductor. The applied bias voltage establishes an electric field inside the photoconductor so that the charge carriers released by the absorption of an X-ray photon can be drifted and collected so as to result in deposition of charge on capacitor C1. As will be described in detail later, capacitor C1 integrates the current induced by the drift of the carriers; and the integrated current, the charge on capacitor C1, represents what appears to be collected from the photo-generated carriers.

In the example illustrated in FIG. 1, when the pixel receives X-ray radiation, and the photo-generated charge in the photoconductor is collected on capacitor C1. An a-Si:H (hydrogenated amorphous silicon) TFT switch is shown in FIG. 1. As indicated in FIG. 1, the TFT switch allows the charge Q1 on capacitor C1 to be read out into the external circuit that may have a charge amplifier (not shown). When gate G1 of the TFT is activated, the TFT switches on, and the charge Q1 on capacitor C1 is readout as AQ1 where A is the amplifier gain. The amount of charge Q1 that is generated depends on the incident radiation X1 on that particular pixel inasmuch as the number of electron and hole pairs generated in the photoconductor is proportional to the photon flux and the photon energy. The X-ray image may, therefore, be represented in terms of the charges residing on the pixel storage capacitors of the FPXI.

Depending on particular applications of FPXIs different photoconductor may be suitable. Table 1 summarizes some of the properties of various X-ray photoconductors that may be used in FPXIs for various applications.

TABLE 1

| Photoconductor | δ at 5 keV | | | | Electron | Hole |
|---|---|---|---|---|---|---|
| State | δ at 20 keV | | Eg | | mobility | mobility |
| Preparation | δ at 60 keV | | (eV) | W± (eV) | μe τ e (cm2/V) | μhτh (cm2/V) |
| Stabilized a-Se | 7.7 | μm | | | | |
| Amorphous | 49 | μm | | 45 at 10 V/μm | | |
| Vacuum deposition | 998 | μm | 2.2 | 20 at 30 V/μm | 3 × 10⁻⁷ − 10⁻⁵ | 10⁻⁶ − 10⁻⁵ |
| HgI₂ | 0.94 | μm | | | | |
| Polycrystalline | 32 | μm | | | | |
| PVD | 252 | μm | 2.1 | 5 | 10⁻⁵ − 10⁻³ | 10⁻⁶ − 10⁻⁵ |
| HgI₂ | 0.94 | μm | | | | |
| Polycrystalline | 32 | μm | | | | |
| (SP) | 252 | μm | 2.1 | 5 | 10⁻⁶ − 10⁻⁵ | ~10⁻⁷ |
| Cd_{0.95}Zn_{0.05}Te | | | | | | |
| Polycrystalline | 1.35 | μm | | | | |
| Vacuum deposition | 80 | μm | | | | |
| (sublimination) | 250 | μm | 1.7 | 5 | ~2 × 10⁻⁴ | ~3 × 10⁻⁶ |
| PbI₂, | 1.1 | μm | | | | |
| Polycrystalline | 28 | μm | | | | |
| Normally PVD | 259 | μm | 2.3 | 5 | 7 × 10⁻⁸ | ~2 × 10⁻⁶ |
| PbO, | 1.26 | μm | | | | |
| Polycrystalline | 12 | μm | | | | |
| Vacuum deposition | 218 | μm | 1.9 | 8-20 | 5 × 10⁻⁷ | small |
| TlBr | 1.38 | μm | | | | |
| Polycrystalline | 18 | um | | | | |
| Vacuum deposition | 317 | μm | 2.7 | 6.5 | small | 1.5⁻³ × 10⁻⁶ |

Some typical or expected properties of selected x-ray photoconductors for large area applications. δ is the attenuation depth at the shown photon energy of 5 keV, 20 keV and 60 keV. μτ represents the carrier range. (PVD refers to physical vapor deposition; SP refers to screen printing).

In clinical applications, it is desirable that nearly all the incident X-ray radiation be absorbed within a practical photoconductor thickness to avoid unnecessary patient exposure. Thus, for clinical applications, it is desirable that the linear attenuation coefficient α be sufficiently large to allow the incident photons (within the energy range of interest) to be attenuated inside the photoconductor. Put differently, the X-ray attenuation depth δ, which is the reciprocal of α must be substantially less than the photoconductor layer thickness L (i.e., δ<<L). The fraction of incident photons in the beam that are attenuated by the photoconductor depends on the linear attenuation coefficient α of the photoconductor material and its thickness L; and is given by

AQ=Attenuated fraction=[1−exp(−αL)] Equation (1)

where α=a (Eₚₕ,Z,ρ) is a function of photon energy Eₚₕ, atomic number Z and density p of the material. AQ is also called the “quantum efficiency” (QE) because it describes the efficiency with which the medium attenuates photons. The attenuation depth δ is where the beam has been attenuated by 63%.

Due to the exponential nature of absorption in Equation (1) a doubling of L can only result in a further 63% attenuation of the remaining beam for a total attenuation of 63+37×0.63≈86%. For example, a-Se has an attenuation depth of 49 μm at 20 keV (within the mammographic range). Thus, for an a-Se layer with a nominal thickness of about 200 μm, AQ is about 98.3%. At higher energies, for example at 60 keV, S for a-Se is about 998 μm. For an a-Se layer of thickness 1,000 μm, therefore, AQ is only 63.2%. Theoretically, increasing the thickness would increase AQ. Practically, however, since the required bias voltage increases with increasing thickness, designing sensors using thicker a-Se layers may not be feasible. As can be seen in Table 1, photoconductors with higher-Z components such as PbO, PbI₂, HgI₂, CdZnTe, which have very good quantum efficiencies in the high energy range (as used in, e.g., chest radiography and angiography) may be advantageous in applications using high energy X-rays.

Once the charges are generated by the absorption of X-rays, these charges can be collected by applying a field F shown in FIG. 1 under which, the electrons and holes drift in opposite directions towards their respective electrodes. In order to obtain a strong signal, it is desirable that carriers not be lost due to recombination or trapping during charge transport. Thus, if τ is the mean lifetime of a charge carrier, and μ is the drift mobility of the carrier, μτF represents the mean distance drifted by the carrier before it is trapped (or disappears by recombination); this distance is referred to herein as the “schubweg.” Since it is desirable that most of the charges, both electrons and holes, be collected, it is desirable that the schubwegs for electron and hole are both much longer than the thickness of the photoconductive layer, that is, μτF>>L for both electrons and holes. If the photoconductor layer is made thicker to capture more of the radiation (towards increasing AQ), the μτF F>>L condition would eventually be lost, and charge collection efficiency would start limiting the sensitivity. The drift mobility×lifetime product, μτ is normally called the range of the carrier, (in other words, its schubweg per unit field). Table 1 also compares the carrier ranges among various large area X-ray photoconductors.

One of skill in the art will appreciate that the inner shell electrons do not necessarily propagate along the initial direction of the impinging X-ray photons. As a result, the pixel collection area extends laterally and perpendicularly to the direction of the impinging X-ray photon and provides more opportunities for trapping of carriers laterally far away from the initial point of penetration of the X-ray photon.

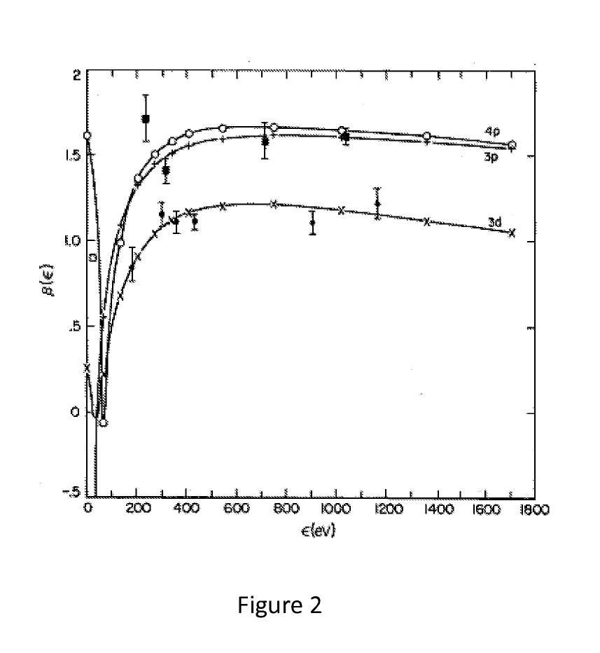

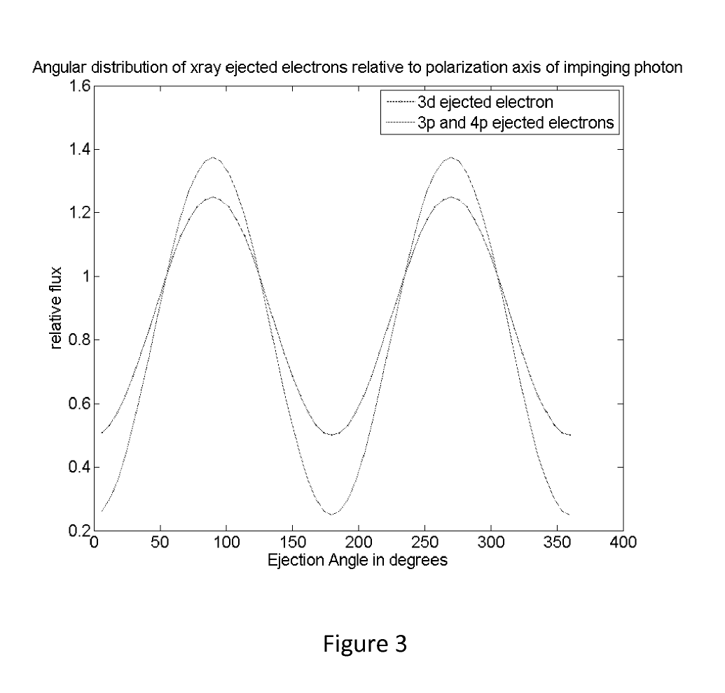

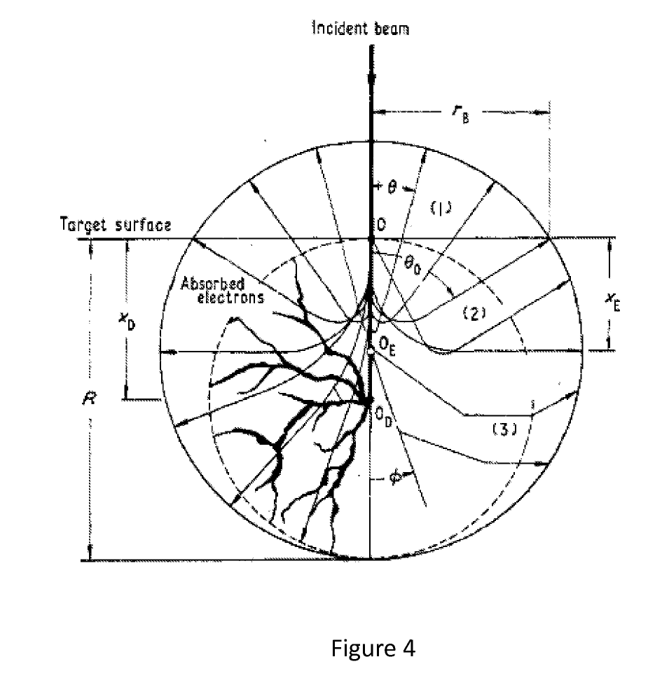

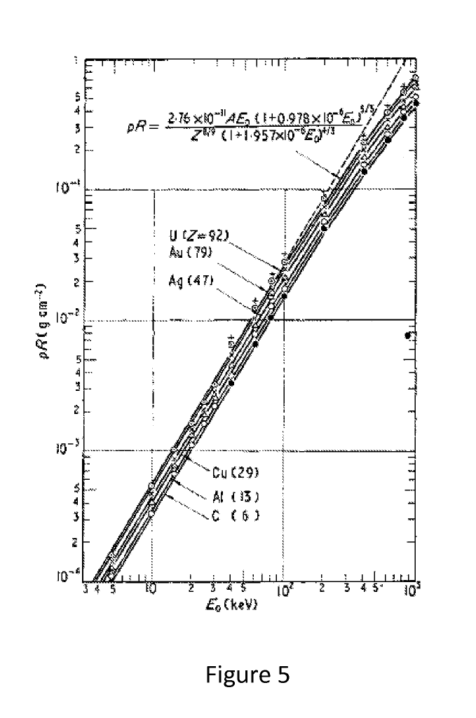

The angular distribution of an ejected electron relative to the plane of polarization of the impinging X-ray photon for unpolarized light is described by

$$1 - \frac{1}{2} β P 2 ( cos ( φ ) \qquad Equation ( 2 )$$

where the asymmetry parameter β ranges from 1 to 1.5 for 3d and 3p electrons (as can be seen in FIG. 2). The angular distribution given by Equation (2) is plotted in FIG. 3. Once these high energy electrons are ejected, they travel through the substrate material and lose energy by electron, hole and phonon production. The phonons subsequently dissipate as heat. A single high energy electron, in the absence of an external field, traces a path depicted in FIG. 4 as it slows down and finally stops. The trajectory shown in FIG. 4 extends in all three dimensions. The range R, which depends on the atomic number Z of the material, for various materials is shown in FIG. 5. In a-Se, a 10 keV electron has a range of about 1 μm whereas a 100 keV electron has a range of 40 μm.

This in turn implies that there is a minimum pixel size for planar geometry, dependent on X-ray energy, determined by the trace of the combined ejected high energy electrons (referred to as the “blur circle”), since each ejected electron traces its own volume (e.g., a sphere with a radius R). One of ordinary skill in the art will appreciate that an ideal X-ray detector would provide line of sight incident photon information that coincides with the point of impact of the X-ray photon with the detector. Any deviation from this in a real device would contribute to blurring of the information at best, or reducing the dynamic range of the detected image through fogging.

Another desirable aspect of a photoconductor suitable for FPXIs is high intrinsic X-ray sensitivity. In other words, a photoconductor that is able to generate as many collectable (free) electron hole pairs (EHPs) as possible per unit of absorbed radiation is more desirable. The amount of radiation energy required, denoted as W±, to create a single free electron and hole pair is referred to herein as “electron-hole pair creation energy” or the “ionization energy.” Thus, the free (or collectable) charge, ΔQ, generated from an incident and absorbed radiation of energy ΔE is eΔE/W±, where e is the elementary charge.

Yet another desirable aspect of a photoconductor is low “dark-current.” “Dark-current” refers to a signal output by a pixel when there is no X-ray radiation impinging on the pixel. In order for a material to have a low dark current, it is desirable that charge collection efficiency be sufficiently high for both electrons and holes.

In certain embodiments, a material with high intrinsic X-ray sensitivity may result in a high dark current if the applied electric field (which may be of the order of 10 V/μm) results in charge carriers at room temperature without exposure to X-ray photons. Such dark current may act as a source of noise in the FPXI, and it is, therefore, desirable to reduce the dark current. One way to reduce the dark current is through appropriate choice of the photoconductor material. Another way to reduce the dark current is by providing a p-like blocking layer to prevent injection of electrons from the negative electrode and an n-like blocking layer to prevent injection of holes from the positive electrode. It must be noted that as used herein, the terminology used to describe the n- and p-layers does not necessarily relate to the Fermi levels of these layers as in traditional semiconductor physics. Rather, the terminology is merely indicative of the relative charge carrier transport properties of the respective materials.

Depending on the particular material used for the n-like or the p-like blocking layers, the thickness of the respective layers may range from about 20 nm to about 8 μm. One of skill in the art will appreciate that the thickness of the blocking layers will also depend on factors such as, for example, the photoconductor material and thickness, energy of impinging X-ray photons, applied voltage bias, etc. Examples of hole-blocking (n-like) materials include, but are not limited to, cerium oxide (CeO₂), titanium oxide (TiO₂), perylene tetracarboxylic bisbenzimidazole (PTCBI), polyimide (PI), or other materials having poor hole transport characteristics. Examples of electron-blocking (p-like) materials include, but are not limited to, amorphous arsenic selenide (As₂Se₃), or other materials having poor electron transport characteristics.

One skilled in the art will appreciate that while the embodiment of FIG. 1 is simple by design and relatively straight-forward to manufacture, thickness of the photoconductor material in such an embodiment would need to be fairly high to achieve desirable imaging properties, particularly for high-energy applications. Practically, this would result in a large voltage bias between the top and bottom electrodes. For example, at an operating point of 10 V/μm, a 500 μm thick film will require a 5 kV bias. Various embodiments described herein address the problem of balancing the thickness of the photoconductor material with charge collection efficiency by providing the photoconductor material in the shape of vertical microstructures aimed at reducing the distance a photo-generated carrier has to travel before being collected at an electrode. Additionally, and advantageously, the structures of various embodiments described herein reduce the voltage bias between the top and bottom electrodes by more than an order of magnitude by significantly reducing the maximum distance travelled by carriers before collection at respective electrodes.

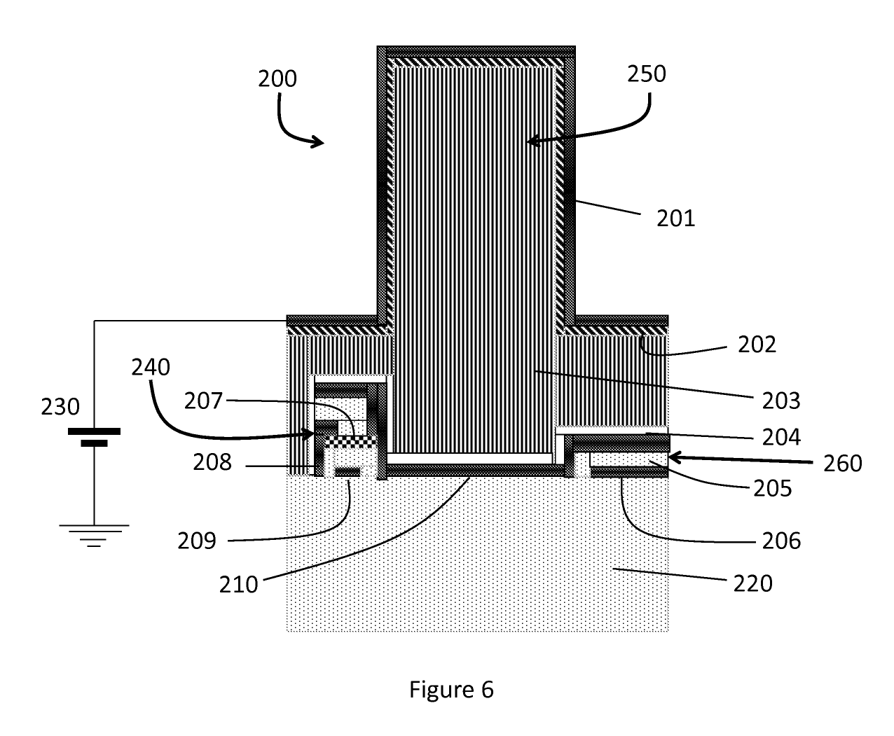

FIG. 6 depicts a schematic cross-section of a single pixel 200 of an FPXI, in accordance with an embodiment of the present disclosure. As depicted in FIG. 6, pixel 200 includes a photoconductor layer 203 sandwiched between an n-like blocking layer 202 on top of photoconductor layer 203 and a p-like blocking layer 204 on the bottom of photoconductor layer 203. A top electrode 201 is disposed on top of n-type blocking layer 202 on a side opposite photoconductor layer 203. Pixel electrode 210 is disposed in contact with p-like blocking layer 204 on a side opposite photoconductor layer 203. In addition to performing the function of the bottom electrode for photoconductor layer 203, pixel electrode 210 forms the source of a thin-film transistor (TFT) 240 with gate 209 and channel 207. Electrode 208 forms the drain of TFT 240. Pixel electrode 210 also forms an electrode of a capacitor 260, which has a dielectric material 205 and a ground electrode 206. The entire structure is disposed on and supported by substrate 220. In the embodiment illustrated in FIG. 6, a positive bias is provided to top electrode 201 using a battery 230. It is contemplated that depending on the material properties of photoconductor layer 203, it may be suitable to provide a positive bias to pixel electrode 210 relative to top electrode 201, which may be grounded.

As depicted in FIG. 6, photoconductor layer 203 is formed into a vertical microstructure 250, in the shape of a pillar structure having a high-aspect ratio. The term “aspect-ratio” as used herein refers to the ratio of a vertical dimension of a structure to the largest horizontal dimension of the structure. For example, in case of a pillar structure having a cylindrical cross-section, the ratio of height of the cylinder to its diameter would form the aspect-ratio. By high-aspect ratio, it is meant that the aspect-ratio of the structure is greater than one. Thus, the aspect ratio of the pillar structure may be, for example, about 1.1, about 1.5, about 2, about 2.5, about 3, about 3.5, about 4, about 5, about 10, about 15, about 20, about 25, about 30, about 35, about 40, about 45, about 50, about 100, or any ratio between any two of these values.

In various embodiments, pillar structure 250 may have any cross-sectional shape. For example, pillar structure 250 may have an elliptical, a circular, a convex polygonal or a mesh shaped cross-section. In some embodiments, pillar structure 250 may have a uniform or a non-uniform cross-sectional dimension. For example, in an embodiment, pillar structure 250 may be in the form of a cone or a pyramid tapering away from pixel electrode 210.

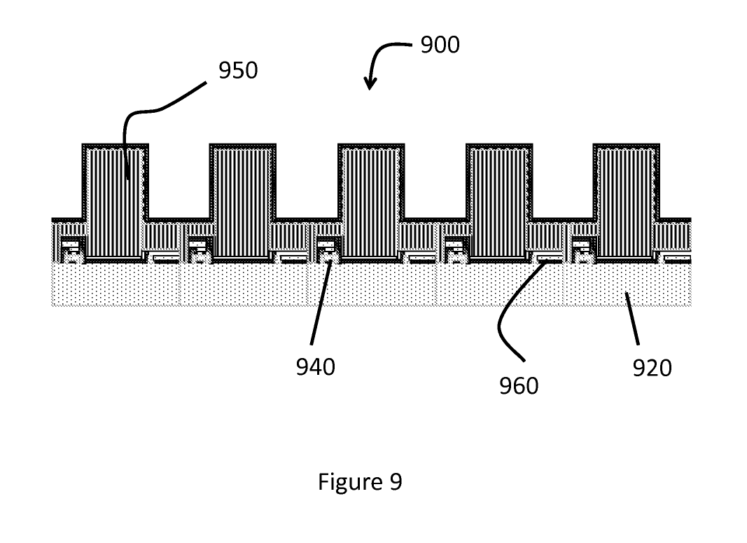

In the context of pillar structure having a square cross-section, for example, the pillar structure may have a side length of about 10 μm to about 100 μm and a height of about 100 μm to about 500 μm. Thus, a pillar structure with square cross-section may have a side length of about 10 μm, 11 μm, 12 μm, about 13 μm, about 14 μm, about 15 μm, 16 μm, about 17 μm, about 18 μm, about 19 μm, about 20 μm, about 25 μm, about 30 μm, about 35 μm, about 40 μm, about 45 μm, about 50 μm, about 60 μm, about 70 μm, about 80 μm, about 90 μm, about 100 μm, or any dimension between any two of these dimensions. Likewise, a pillar structure may have a height of about 100 μm, about 105 μm, about 110 μm, about 115 μm, about 120 μm, about 125 μm, about 150 μm, about 175 μm, about 200 μm, about 225 μm, about 250 μm, about 275 μm, about 300 μm, about 350 μm, about 400 μm, about 450 μm, about 500 μm, or any other height between any two of these heights. It is contemplated that within a flat-panel X-ray imager having multiple pixels (e.g., such as one depicted in FIG. 9), the largest horizontal dimension (i.e., diameter, side, etc.) and/or the height of pillar structures of various pixels may be varied depending on particular applications.

In various embodiments, pixel electrode 210 and top electrode 201 may be formed of a suitable metal such as, for example, Al, Au, Ag, Cu, Pt, and the like, or any combination thereof.

Any suitable structure known in the art may be used for TFT 240. For example, a standard amorphous silicon TFT may be used. Likewise, any suitable dielectric material 205 such as, for example, SiO₂, Al₂O₃, MgNb₂O₆, ZnNb₂O₆, MgTa₂O₆, (ZnMg)TiO₃, (ZrSn)TiO₄, Ba₂Ti₉O₂₀, TiO₂, and the like or any combinations thereof may be used in capacitor 260. Suitable materials for substrate 220 may include, for example, glass, ITO coated glass, quartz, Al₂O₃, dielectric polymers, and the like, or any combinations thereof.

As has been described herein, within the constraints of signal-to-noise ratio S/N and dynamic range of FPXIs, the smallest pixel size can be designed by controlling the size of the blur circle by choosing an appropriate pillar dimension. The pillar geometry of individual pixels advantageously confines the lateral migration of the inner shell electrons inside the pillar resulting in less pixel cross talk, and reduces loss of free carriers (e.g., to recombination and trapping) and its attendant deleterious effects described elsewhere herein. Thus, for a pillar-structured pixel (e.g., pixel 200), the charge collection efficiency is higher than that of the planar pixel (e.g., as illustrated in FIG. 1) case due to the short travel distance to collection and reduced probability for carrier trapping. The pillar-shaped geometry of pixels can, thus, achieve the same schubweg as the planar device but with much reduced bias potential.

The pillar geometry illustrated in FIG. 6 reduces the distance a majority carrier has to travel to be collected at the contacts. For example, since the top electrode is biased positive, photo-generated electrons are collected along the entire surface of the pillar relatively close to their point of origin. This reduces the probability of electron trapping. In other words, the electron schubweg is significantly reduced. The holes, however, still have to travel down the length of the pillar to be collected at the pixel electrode. Thus, there is an asymmetry in terms of distance travelled by holes and electrons before being collected at their respective electrodes. One skilled in the art will appreciate that this asymmetry could be exploited to force the carrier species with the higher mobility to travel the longer distance. For example, photoconductor materials such as CdZnTe, PbI₂ or HgI₂ all have electrons mobilities that are much higher the hole mobilities. Thus, while using such materials, it may be advantageous to bias the pixel electrode positive so as to force electrons to travel longer distances before being collected. Other configurations are also contemplated.

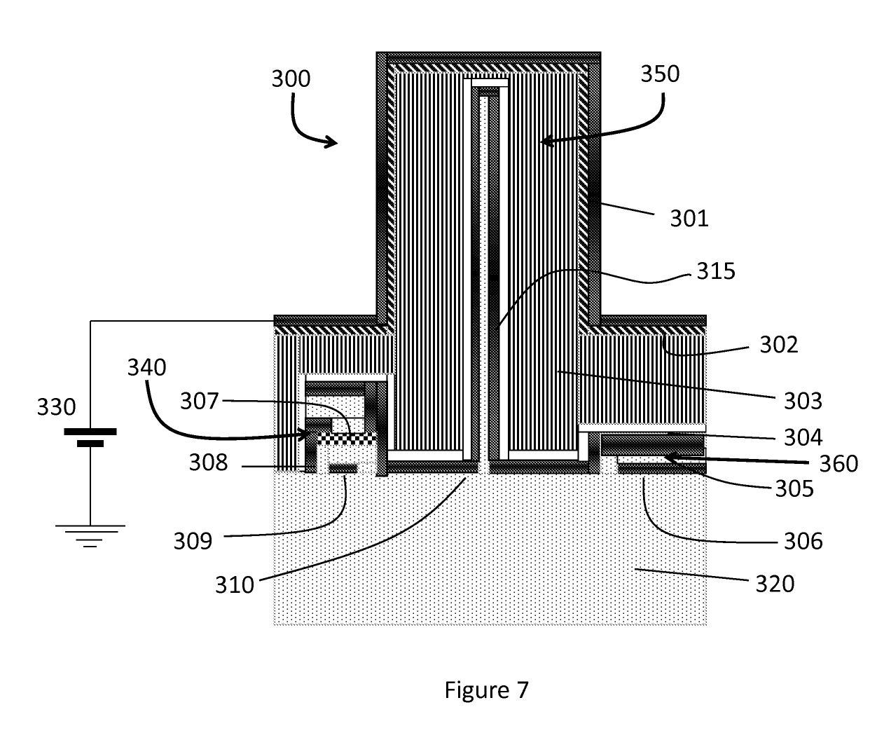

FIG. 7 depicts a schematic cross-section of a single pixel 300 of an FPXI, in accordance with an embodiment of the present disclosure. As depicted in FIG. 7, pixel 300 includes a photoconductor layer 303 sandwiched between an n-like blocking layer 302 on top of photoconductor layer 303 and a p-like blocking layer 304 on the bottom of photoconductor layer 303. A top electrode 301 is disposed on top of n-type blocking layer 302 on a side opposite photoconductor layer 303. Pixel electrode 310, which forms the bottom electrode for photoconductor layer 303, is disposed on the bottom of p-like blocking layer 304 on a side opposite photoconductor layer 303. Pixel electrode 310, additionally, forms the source of a thin-film transistor (TFT) 340, which has a gate 309 and a channel 307. Electrode 308 forms the drain of TFT 340. Pixel electrode 310 also forms an electrode of a capacitor 360, which has a dielectric material 305 and a ground electrode 306. The entire structure is disposed on and supported by substrate 320. A positive bias may be provided to top electrode 301 using a battery 340. Pixel 300 is substantially similar to pixel 200 depicted in FIG. 6 with the exception of pixel electrode 310 extending into a center electrode 315 along a central axis of pillar 350.

Presence of center electrode 315, as depicted in FIG. 7, reduces the travel path for both holes and electrons regardless of the direction of the applied electric field. Any carriers generated by the X-ray photons impinging on the photoconductor material are collected along the entire surface of pixel electrode 310 (including center electrode 315) or the entire surface of top electrode 301 depending on the bias applied. Thus, the asymmetry in travel paths of carriers may be reduced by appropriately choosing the dimensions of the pillar structure and the center electrode. While top electrode 301 is shown to be positively biased in FIG. 7, one skilled in the art will appreciate that this is not limiting.

As discussed above, it may be desirable for the pillar structures to have a minimum width (e.g., diameter in the context of cylindrical pillars) so that most of the X-ray photons are absorbed within the photoconductor material of the pillar structures. On the other hand, a minimum separation between neighboring pixels is desirable to reduce cross-talk between pixels. Pixel size, and distance between neighboring pixels (also referred to herein as “pixel pitch”), therefore, has to be optimized depending on the particular application of an FPXI using the pillar structured pixels described herein. Factors such as, for example, image resolution, materials used, fabrication methods and technologies used, and so forth may, in various embodiments, determine the number and density of pixels used for a particular FPXI. It will be appreciated that in an FPXI using pixel 200 or pixel 300, the pixel number and pixel pitch may be chosen appropriately depending on the particular application.

Depending on the incident X-ray flux, it may be desirable, in some embodiments, to have a significantly high pixel density in order to capture majority of X-rays. Alternatively, in some embodiments, a very high image resolution may be desirable (e.g., in medical applications). In such embodiments, pixel density may be increased by inverted stacking of the pillar structured pixels in staggered configuration. Such a configuration may increase pixel density without adversely affecting pixel cross-talk.

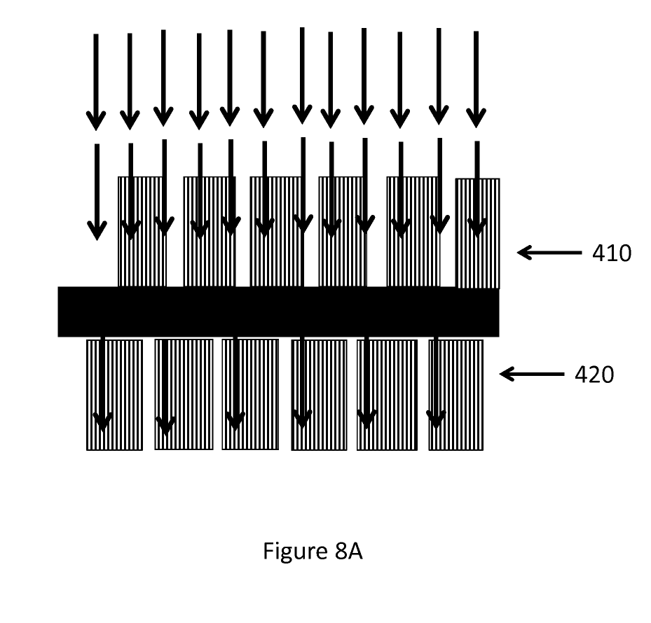

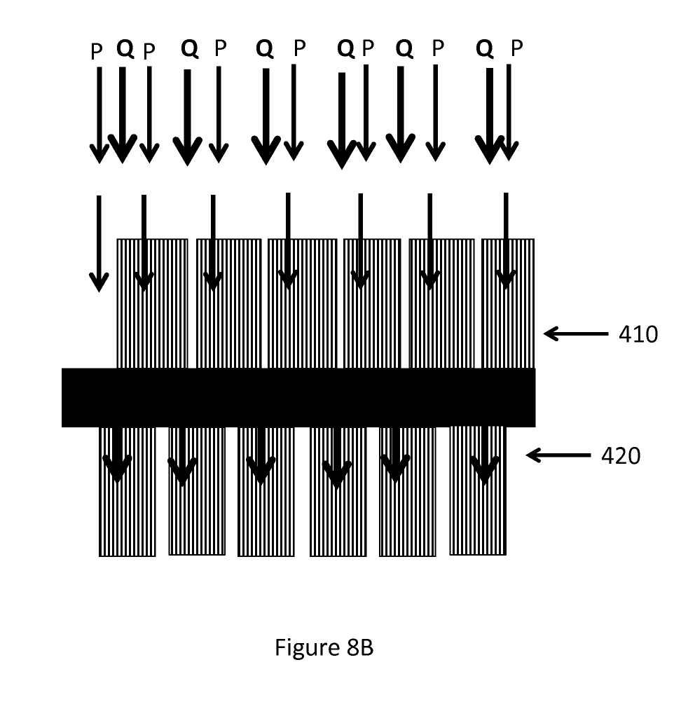

FIGS. 8A and 8B depict a schematic cross-section of an FPXI pixel array having a stacked (also referred to herein as “double-sided”) configuration, in accordance with an embodiment of the present disclosure. In the embodiment depicted in FIGS. 8A and 8B, a second array 420 of pixels (e.g., pixels 200, or pixels 300) is disposed on the bottom-side of the substrate of a first array 410 of pixels such that the pillar structures extend away from each other. In an embodiment, second array 420 may be staggered with respect to first array 410 such that the pillar structures of second array 420 correspond to the gaps between pillar structures of first array 410. In some embodiments, second array 420 may have a pitch and pixel size (i.e., pillar width and height) that is substantially the same as first array 410. In an embodiment, second array 420 may have a pillar width that equal to the pixel pitch of first array 410. In such an embodiment, the pillars of second array 420 may be disposed in a configuration such that the pillars of second array 420 fill the gaps between the pillars of first array 410. In an embodiment, the pitch and pixel size of second array 420 may be different than the pitch and pixel size of first array 410.

In a double-sided configuration, the X-ray photons that pass through the gaps between the pillars of the first array necessarily pass through the pillars of the second array Thus, advantageously, the double-sided configuration (e.g., as depicted in FIGS. 8A and 8B), reduces the number of X-ray photons escaping the FPXI without absorption.

Additionally, as depicted in FIG. 8B, while majority of low energy X-ray photons P may get absorbed by pillars of first array 410, high energy X-ray photons Q may pass through pillars of first array 410 without getting absorbed. These may be absorbed by second array 420, since high-energy photons Q have to travel through the thickness of pillars of first array 410 and pillars of second array 420. Thus, advantageously, by tailoring the sizes of pillars in first array 410 and second array 420, the X-ray photons of various energies may be absorbed, allowing imaging in applications requiring different X-ray energies using a single double-sided FPXI.

In various embodiments, the pitch and pillar size for the second array may be different from the pitch and pillar size for the first array.

It is contemplated that depending on particular applications, the pitch and pillar size of pixels within an FPXI pixel array of various embodiments disclosed herein may be varied so as to capture X-ray photons of various energies. For example, a single FPXI may have pillars having a height of 10 μm, 20 μm, 50 μm, 100 μm, and 500 μm, and a width of 5 μm, 10 μm, 25 μm, 50 μm, and 100 μm respectively, on a first side of the substrate and pillars having a height of 25 μm, 75 μm, 150 μm, 250 μm, and 300 μm, and a width of 10 μm, 25 μm, 50 μm, 100 μm, and 150 μm respectively on a second side of the substrate. The pitch for the pillars on the first side may be, for example, 20 μm, 40 μm, 100 μm, 200 μm, and 1000 μm respectively. The pitch for the pillars on the second side may be, for example, 20 μm, 50 μm, 100 μm, 200 μm, and 300 μm respectively. It will be appreciated that the dimensions provided herein are merely illustrative and not limiting. Other dimensions are contemplated. One skilled in the art will appreciate that while an example of a double-sided configuration is described above, similar variation in heights of pillars and pitch for the pillars may be provided in the one-sided arrays of embodiments illustrated in FIGS. 6 and 7.

Embodiments of the devices and systems described herein may be used for any suitable application where detecting X-rays is required. For example, the devices and systems described herein may be used in X-ray telescopes, X-ray spectroscope, X-ray lithography systems, medical imaging systems such as, for example, X-ray computed tomography, baggage screening systems, systems for defect detection on assembly lines, and so forth. Embodiments illustrating the methods and materials used may be further understood by reference to the following non-limiting examples:

### EXAMPLES

### Example 1

### Flat Panel X-Ray Imagers Having Micro Pillars

FIG. 9 depicts a flat panel X-ray imager (FPXI) 900 having an array of pillars of a photoconductor material, in accordance with an embodiment of the present disclosure. FPXI 900 includes an array of pillars 950, and an array of TFT switches 940 and capacitors 960, such that each of a pair of switches 940 and capacitors 960 corresponds to each of the pillars 950. The array is disposed on a substrate 920.

In the embodiment depicted in FIG. 9, each of the pillars 950 has a cylindrical cross-section of a diameter of about 15 μm and a height of about 150 μm. The center-to-center distance between neighboring pillars is about 40 μm. Each of the pillars 950 comprises mercury iodide (HgI₂) as a photoconductor material.

FPXI 900 depicted in FIG. 9 is fabricated using standard semiconductor manufacturing processes known in the art. For example, to fabricate FPXI 900 a glass substrate 920 is used a starting point. An array of capacitors 960 and TFTs 940 and their corresponding connecting wires are fabricated on substrate 920 in accordance with the desired design parameters for FPXI 900. Capacitors 960 and TFTs 940 are fabricated using standard semiconductor manufacturing processes (e.g, photolithography, physical vapor deposition, chemical vapor deposition, wet chemical etching, reactive ion etching, oxygen plasma etching, and the like) known in the art. A p-like blocking layer is then deposited on the electrodes for capacitors 960 and TFTs 940 using techniques known in the art such as, for example, physical or chemical vapor deposition, spin-coating, screen printing, and the like. This is then followed by a thick film deposition (about 150 μm in thickness) of photoconductor material HgI₂ on top of the p-like blocking layer. HgI₂ may be deposited using any method known in the art such as, for example, screen printing or physical vapor deposition. Next, the HgI₂ layer is etched into a pillar array such that each pillar is adjacent to or on top of its corresponding pair of capacitor and TFT. The film etch is stopped a certain minimum thickness above the substrate. (e.g. 50 μm). An n-like blocking layer is then deposited on top of the HgI₂ film followed by a metallic thin film that acts as the top electrode for the FPXI.

The minimum thickness of HgI₂ prevents shorting of the top and bottom electrodes once a voltage bias is applied across the pillar array. It is desirable that the minimum thickness be at least equal to the attenuation depth of the X-rays in HgI₂ so that X-rays not passing through the pillars have a low probability of escaping FPXI 900 unabsorbed. One of skill in the art will appreciate that the minimum thickness is determined by the material properties of the photoconductor material (e.g., HgI₂ in the embodiment depicted in FIG. 9) and energy of the incident X-rays used in the particular application.

Advantageously, in the embodiment depicted in FIG. 9, depending on the direction of the bias applied across the photoconductor material, one of carrier types has a short travel path before getting collected by the electrode along the pillar surface. The array can, therefore, be designed and biased to provide a shorter path for carriers with lower mobility values. Since holes have lower mobility in most materials, the pixel electrode may be biased positive with respect to the pillar surface (i.e., top electrode) so that holes are collected at the pillar surface and electrons are collected at the pixel electrode.

### Example 2

### Flat Panel X-Ray Imagers Having Micro Pillars with Central Electrode

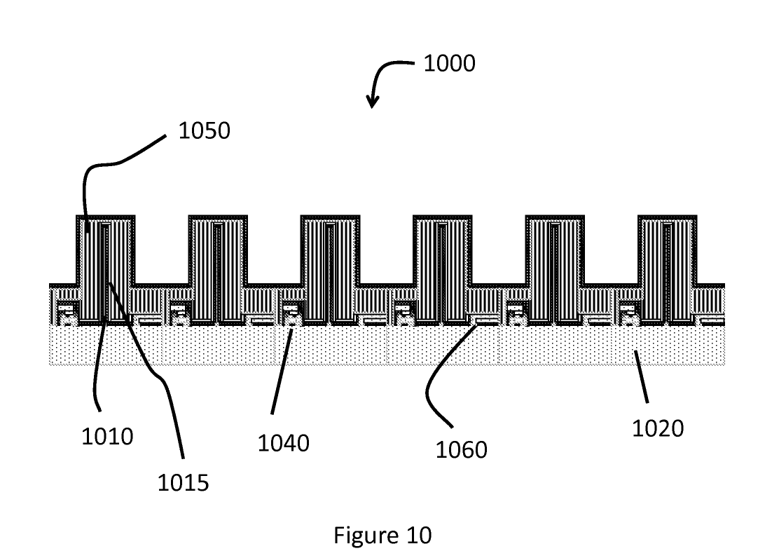

FIG. 10 depicts a flat panel X-ray imager (FPXI) 1000 having an array of pillars with a central electrode, in accordance with an embodiment of the present disclosure. FPXI 1000 includes an array of pillars 1050, and an array of TFT switches 1040 and capacitors 1060, such that each switch 1040 and capacitor 1060 corresponds to a pillar 1050. Each of the pillars 1050 has an electrode 1015 extending along the central axis of the pillar. The array is disposed on a substrate 1020.

In the embodiment depicted in FIG. 10, each of the pillars 1050 has a cylindrical cross-section of a diameter of about 50 μm and a height of about 300 μm. The center-to-center distance between neighboring pillars is about 75 μm. Each of the pillars 1050 comprises lead iodide (PbI₂) as a photoconductor material, and has an electrode 1015 along its central axis.

FPXI 1000 depicted in FIG. 10 is fabricated using standard semiconductor manufacturing processes known in the art. For example, to fabricate FPXI 1000 a glass substrate 1020 is used a starting point. Glass 1020 is etched to form a gird of micro pillars 1010 having a diameter of about 10 μm and a length of about 250 μm. Neighboring micro pillars 1010 have a center-to-center distance of about 75 μm. An array of capacitors 1060 and TFTs 1040 and their connecting wires are fabricated next to each of the micro pillars 1015 in accordance with the desired design parameters for FPXI 1000. Capacitors 1060 and TFTs 1040 are fabricated using standard semiconductor manufacturing processes (e.g, photolithography, physical vapor deposition, chemical vapor deposition, wet chemical etching, reactive ion etching, oxygen plasma etching, and the like) known in the art. A p-like blocking layer is then deposited using known techniques on the electrodes for capacitors 1060 and TFTs 1040. This is then followed by a thick film deposition (about 300 μm in thickness) of photoconductor material PbI₂ on top of the p-like blocking layer. PbI₂ may be deposited using any method known in the art such as, for example, screen printing or physical vapor deposition. Next the PbI₂ layer is etched into a pillar array 1050 such that each pillar 1050 has a micro pillar 1010 along its central axis, and is adjacent to or on top of its corresponding pair of capacitor and TFT. The film etch is stopped a certain minimum thickness above the substrate. (e.g. 50 μm). An n-like blocking layer is then deposited using known techniques on top of the PbI₂ film followed by a metallic thin film that acts as one of the electrodes for the FPXI.

The minimum thickness of PbI₂ prevents shorting of the top and bottom electrodes once a voltage bias is applied across the pillar array. It is desirable that the minimum thickness be at least equal to the attenuation depth of the X-rays in PbI₂ so that X-rays not passing through the pillars have a low probability of escaping FPXI 1000 unabsorbed. One of skill in the art will appreciate that the minimum thickness is determined by the material properties of the photoconductor material (e.g., PbI₂ in this example) and energy of the incident X-rays used in the particular application.

In the array depicted in FIG. 10, central electrode 1015 forms an extension of the pixel electrode. Thus, advantageously, both holes and electrons have a short travel path (no more than about 20 μm) before being collected at an electrode. A typical photoconducting material may require about 10 V/μm bias for effectively collecting the charge carriers. As a result of reduced path length, FPXI 1000 may function effectively at a bias as low as 200 V.

### Example 3

### Flat Panel X-Ray Imagers Having a Double-Sided Configuration

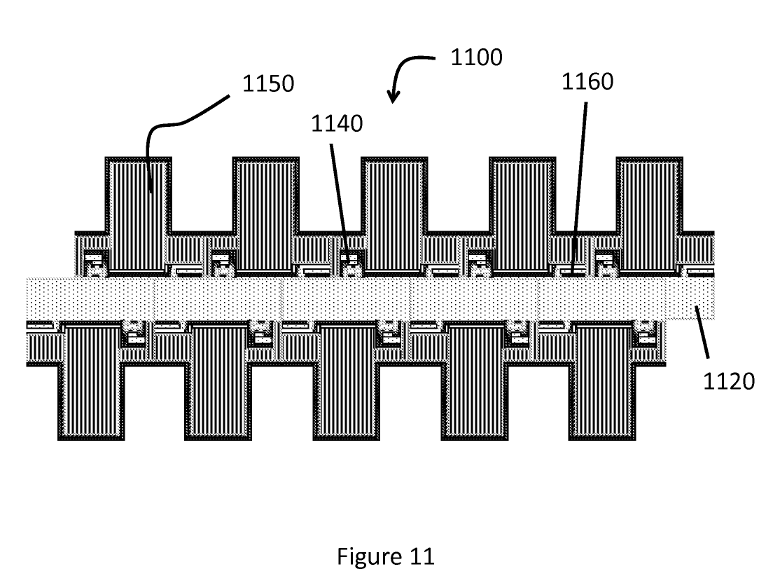

FIG. 11 depicts a flat panel X-ray imager 1100 having an array of pillars of a photoconductor material in a double sided configuration, in accordance with an embodiment of the present disclosure. As illustrated, FPXI 1100 has an array of pillars 1150A on the top side of substrate 1120 and an array of pillars 1150B on the bottom side of substrate 1120. Arrays 1150A and 1150B are offset with respect to each other such that at least a portion of pillars 1150B is located in a space corresponding to a gap between pillars 1150A. In a 3-dimensional design where the X-rays are incident in the Z direction, pillars 1150A and pillars 1150B may be offset in both the X, and the Y directions. In the example depicted in FIG. 11, pillars 1150A and pillars 1150B are depicted as being similar in design to pillars 950. This depiction is, however, not limiting and one skilled in the art will appreciate that pillars 1050 may be incorporated in the double sided configuration depicted in FIG. 11.

To fabricate the double sided configuration, two FPXIs 900 are fabricated and glued or bonded back-to-back with an appropriate offset. The length by which the FPXIs 900 are offset may be chosen to be just sufficient to ensure that substantially all incoming X-ray photons travel through a thickness of the photoconductor material that is at a minimum as thick as a single sided layer thickness. With such a design, substantially all of the X-ray photons that escape absorption in the top array (i.e., array 1150A) will now be detected in the bottom array (i.e., 1150B).

Another method of fabrication would be to fabricate the TFT circuits on both sides of the substrate with the appropriate registration and subsequently deposit the amorphous selenium and blocking layers.

### Example 4

### Real-Time Tomography Imager

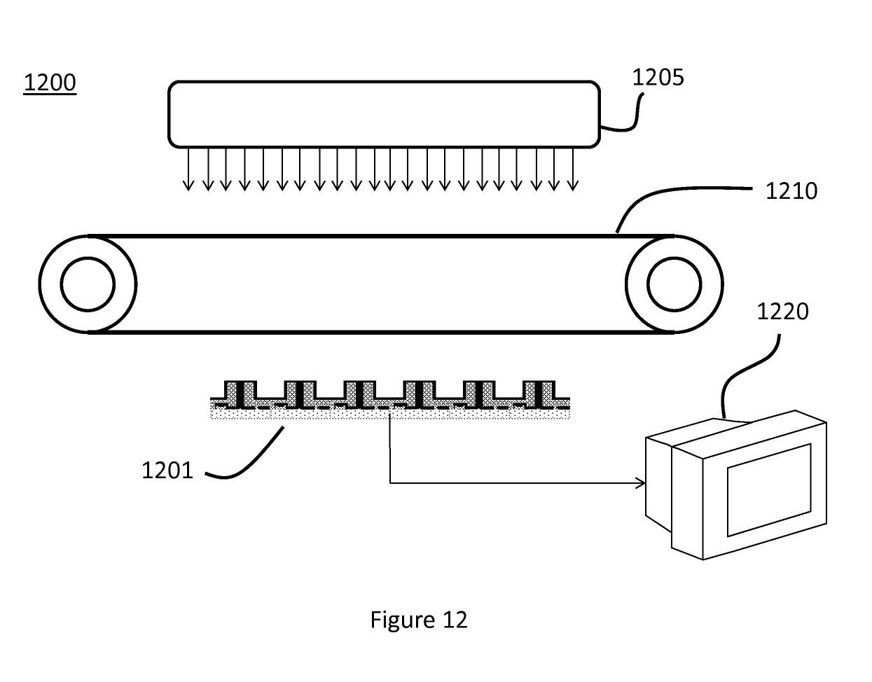

FIG. 12 depicts a schematic of a real-time tomography imaging system 1200, in accordance with an embodiment of the present disclosure. System 1200 includes an X-ray source 1205, a conveyor 1210, an X-ray detector 1201 and an electronic display 1220. Any appropriate X-ray source known in the art may be used for this purpose. X-ray detector 1201 of system 1200 may be any one of the various embodiments of FPXIs described herein. Conveyor 1210 may be used for moving objects (e.g., pieces of luggage) to a scanning area where the objects are exposed to the X-rays from X-ray source 1205. X-rays transmitted through the objects are received at X-ray detector 1201 which generates signals based on the material and shape of the objects. The signals from X-ray detector 1201 are converted into an image by electronic display 1220. The image is based on the signals received from the X-ray detector.

System 1200 may be used for imaging objects present in the scanning area. Examples of objects that may be screened using system 1200 include, but are not limited to, items of luggage (e.g., at an airport), manufactured objects (e.g., for quality control screening for imaging defects), etc.

### Example 5

### Medical Imaging System

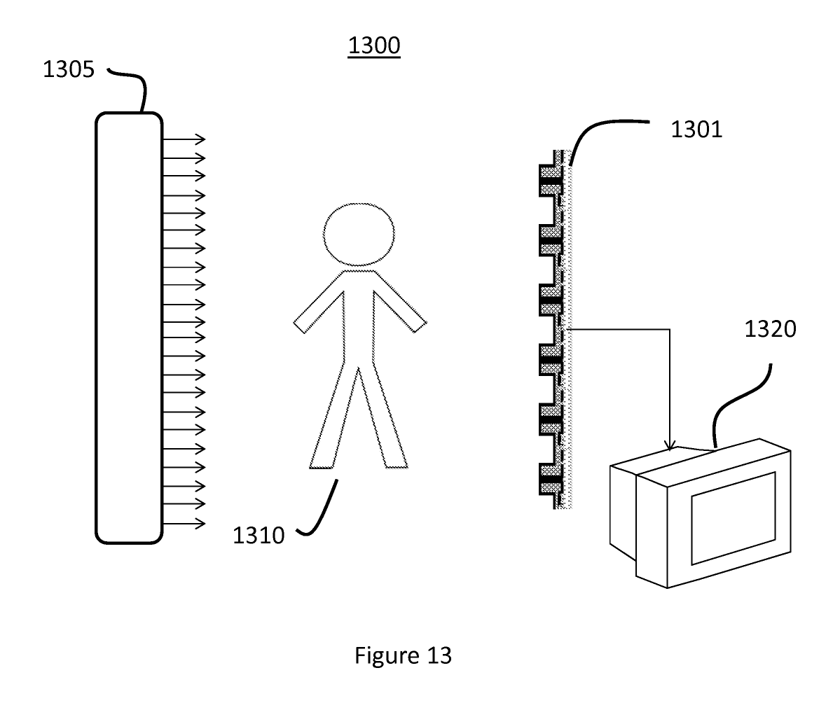

FIG. 13 depicts a schematic of a medical imaging system 1300, in accordance with an embodiment of the present disclosure. System 1300 includes an X-ray source 1305, an X-ray detector 1301 and an electronic display 1320. Any appropriate X-ray source known in the art may be used for this purpose. X-ray detector 1301 of system 1300 may be any one of the various embodiments of FPXIs described herein. A subject 1310 may be positioned in a scanning area where the subject is exposed to the X-rays from X-ray source 1305. X-rays transmitted through the subject are received at X-ray detector 1301 which generates signals based on the anatomy of the subject. The signals from X-ray detector 1301 are converted into an image by electronic display 1320. The image is based on the signals received from the X-ray detector.

The “subject” as used herein includes, but is not limited to, humans and non-human vertebrates such as wild, domestic and farm animals. System 1300 may be used for imaging subjects to obtain, for example, dental X-ray images, mammograms, orthopedic X-ray images, chest X-ray images and so forth.

The foregoing detailed description has set forth various embodiments of the devices and/or processes by the use of diagrams, flowcharts, and/or examples. Insofar as such diagrams, flowcharts, and/or examples contain one or more functions and/or operations, it will be understood by those within the art that each function and/or operation within such diagrams, flowcharts, or examples can be implemented, individually and/or collectively, by a wide range of hardware, software, firmware, or virtually any combination thereof.

The subject matter herein described sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components.

As used herein, the term “about” means that the numerical value is approximate and small variations would not significantly affect the practice of the disclosed embodiments. Where a numerical limitation is used, unless indicated otherwise by the context, “about” means the numerical value can vary by up to ±10% and remain within the scope of the disclosed embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

As will be understood by one skilled in the art, for any and all purposes, such as in terms of providing a written description, all ranges disclosed herein also encompass any and all possible subranges and a combination of subranges thereof. Any listed range can be easily recognized as sufficiently describing and enabling the same range being broken down into at least equal halves, thirds, quarters, fifths, tenths, etc. As will also be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A device comprising:
a first electrode;
a second electrode;
a microstructure; and
an insulating photon absorbing material,
wherein the microstructure is configured to provide an electrical path between the first electrode and the second electrode such that at least a portion of charge carriers generated in the photon absorbing material by incident X-ray are collected in a direction different from the direction of the incident X-ray.

2. The device of claim 1, the microstructure is configured such that a charge carrier generated within the insulating photon absorbing material resulting from impinging X-ray travels a distance of no greater than a product of: (i) mean lifetime of the charge carrier within the photon absorbing material, (ii) drift mobility of the charge carrier, and (iii) an electric field applied between the first electrode and the second electrode, before contacting the first electrode or the second electrode.

3. The device of claim 1, wherein the microstructure comprises a pillar structure on a surface of the substrate, extending away from the substrate and the microstructure comprises the insulating photon absorbing material.

4. The device of claim 1, wherein the pillar structure comprises a central axis comprising a micro-pillar comprising an electrical conductor in electrical contact with the second electrode.

5. The device of claim 1, further comprising a switch in electrical contact with the second electrode.

6. A device comprising:
a substrate having a plurality of pixels thereon, each pixel comprising:
a first electrode;
a second electrode;
a microstructure; and
an insulating photon absorbing material having an attenuation depth of less than about 8 μm for photons having an energy of about 5 keV,
wherein the second electrode is electrically connected with the first electrode via the insulating photon absorbing material.

7. The device of claim 6, wherein the microstructure is configured such that a charge carrier generated within the insulating photon absorbing material resulting from impinging X-rays travels a distance of no greater than a product of: (i) mean lifetime of the charge carrier within the photon absorbing material, (ii) drift mobility of the charge carrier, and (iii) an electric field applied between the first electrode and the second electrode, before contacting the first electrode or the second electrode.

8. The device of claim 6, wherein the microstructure comprises a pillar structure on a surface of the substrate, extending away from the substrate and the microstructure comprises the insulating photon absorbing material.

9. The device of claim 8, wherein the pillar structure has a diameter of about 10 μm to about 100 μm and a height of about 100 μm to about 500 μm.

10. The device of claim 8, wherein the pillar structure has a cross-section including one or more of a circle, an ellipse, a convex polygon, and a mesh.

11. The device of claim 8, wherein the pillar structure is comprises a central axis comprising a micro-pillar comprising an electrical conductor in electrical contact with the second electrode.

12. The device of claim 8, wherein the pillar structure has an aspect ratio of about 2:1 to about 50:1.

13. The device of claim 6, further comprising a switch in electrical contact with the second electrode.

14. The device of claim 13, wherein the switch comprises a transistor and/or a capacitor.

15. The device of claim 6, wherein the microstructure comprises a first pillar structure extending upward from a top side of the substrate and a second pillar structure extending downward from a bottom side of the substrate.

16. The device of claim 6, wherein the microstructure comprises a trench, a recess, an indent, a hole, or any combination thereof, in the substrate.

17. The device of claim 6, wherein the photon absorbing material comprises amorphous selenium (a-Se), mercury iodide (HgI₂), cadmium zinc telluride (CdZnTe), lead iodide (PbI₂), lead oxide (PbO), thallium bromide (TlBr), or any combination thereof.

18. The device of claim 6, further comprising an electronic circuit, in electrical communication with each of the plurality of pixels, configured to process an electrical signal resulting from X-ray photons impinging on the photon absorbing material.

19. A method comprising:
exposing a device to X-ray; and
processing an electrical signal resulting from the X-ray impinging on the device,
wherein the device comprises:
a first electrode;
a second electrode;
a microstructure; and
an insulating photon absorbing material,
wherein the microstructure is configured to provide an electrical path between the first electrode and the second electrode such that at least a portion of charge carriers generated in the photon absorbing material by incident X-ray are collected in a direction different from the direction of the incident X-ray.

20. The method of claim 19, wherein the microstructure is configured such that a charge carrier generated within the insulating photon absorbing material resulting from impinging X-rays travels a distance of no greater than a product of: (i) mean lifetime of the charge carrier within the photon absorbing material, (ii) drift mobility of the charge carrier, and (iii) an electric field applied between the first electrode and the second electrode, before contacting the first electrode or the second electrode.

21. The method of claim 19, wherein the microstructure comprises a pillar structure on a surface of the substrate, extending away from the substrate and the microstructure comprises the insulating photon absorbing material.

22. The method of claim 21, wherein the pillar structure has a diameter of about 10 μm to about 100 μm and a height of about 100 μm to about 500 μm.

23. The method of claim 21, wherein the pillar structure has a cross-section including one or more of a circle, an ellipse, a convex polygon, and a mesh.

24. The method of claim 21, wherein the pillar structure is comprises a central axis comprising a micro-pillar comprising an electrical conductor in electrical contact with the second electrode.

25. The method of claim 21, wherein the pillar structure has an aspect ratio of about 2:1 to about 50:1.

26. The method of claim 19, wherein the device further comprises a switch in electrical contact with the second electrode.

27. The method of claim 26, wherein the switch comprises a transistor and/or a capacitor.

28. The method of claim 19, wherein the microstructure comprises a first pillar structure extending upward from a top side of the substrate and a second pillar structure extending downward from a bottom side of the substrate.

29. The method of claim 19, wherein the microstructure comprises a trench, a recess, an indent, a hole, or any combination thereof, in the substrate.

30. The method of claim 19, wherein the photon absorbing material comprises amorphous selenium (a-Se), mercury iodide (HgI₂), cadmium zinc telluride (CdZnTe), lead iodide (PbI₂), lead oxide (PbO), thallium bromide (TlBr), or any combination thereof.

31. The method of claim 19, wherein processing the electrical signal comprises processing the electrical signal generated at each of the plurality of pixels.

32. A method comprising:
bonding a top side of a first device of claim 1 with a bottom side of a second device of claim 1 such that the microstructure of the first device and the microstructure of the second device extend in a same direction or away from each other.

33. The method of claim 32, wherein the microstructure is configured such that a charge carrier generated within the insulating photon absorbing material resulting from impinging X-rays travels a distance of no greater than a product of: (i) mean lifetime of the charge carrier within the photon absorbing material, (ii) drift mobility of the charge carrier, and (iii) an electric field applied between the first electrode and the second electrode, before contacting the first electrode or the second electrode.

34. A system for real-time tomography, the system comprising:
an X-ray source for projecting X-rays through a screening area; and
an X-ray detector comprising the device of claim 1, and configured to detect X-rays transmitted through an object present in the scanning area.

35. A system for X-ray spectroscopy, the system comprising:
an X-ray source for projecting X-rays through a material sample;
a sample holder for retaining the material sample; and
an X-ray detector comprising the device of claim 1, and configured to detect X-rays transmitted, dispersed, or diffracted by the material sample.

36. A system X-ray telescope comprising:
an aperture arranged and constructed to collect astronomical X-rays;
at least one X-ray mirror; and
an X-ray detector comprising the device of claim 1, and configured to detect the astronomical X-rays.

37. A system for X-ray computer tomography comprising:
an X-ray source for projecting X-rays through an examination region;
an X-ray detector comprising the device of claim 1, and configured to detect X-rays transmitted through a subject present in the examination region; and
an electronic display configured to display an image constructed based on signals received from the X-ray detector.
